(19) United States
(12) Patent Application Publication
(10) Pub. No.: US 2010/0036710 A1
(43) Pub. Date: Feb. 11, 2010

(54) MODULATION OF GEO-TARGETING CONFIDENCE THRESHOLDS IN NETWORK ADVERTISING SYSTEMS

(75) Inventor: Glen Ames, Mountain View, CA (US)

Correspondence Address: BAKER BOTTS L.L.P., 2001 ROSS AVENUE, 6TH FLOOR, DALLAS, TX, 75201, US

(73) Assignee: YAHOO! INC., Sunnyvale, CA (US)

(21) Appl. No.: 12/186,307

(22) Filed: Aug. 5, 2008

(51) Int. Cl. G06Q 30/00; G06Q 10/00

(52) U.S. Cl. 705/10; 705/7

(57) ABSTRACT

Particular embodiments of the present invention are related to a digital media benefit attachment mechanism for generating or attaching revenue rights and other benefits to one or more entities associated with socially distributed media.

### TECHNICAL FIELD

The present disclosure generally relates to targeted advertising systems.

### BACKGROUND

Geographic targeting or “geo targeting,” in Internet marketing and advertising, generally refers to methods of determining the physical or geographic location of a web site user and delivering content, such as targeted ads, to the web site user based on his or her location. Locations can be more general locations, such as country or region/ state, and more specific, such as city, metropolitan region, zip code, and county.

Geo targeting systems are often based on an examination of Internet Protocol (IP) addresses associated with individual web site users against a database that maps IP addresses, ranges and subnets to various geographic locations. Geo targeting can also be accomplished based on geographical and other personal information that were provided by the web site user, as well, such as in connection with a user account. Due to a wide variety of factors including the complexity of the network, the dynamically changing environment and IP address space, geo targeting systems, however, are not perfectly accurate. Indeed, many geo targeting information vendors or systems assign confidence factors to resolved locations based on IP address or other information. For example, the confidence factor for a given mapping between an IP address an a geographic location can be affected by connection attributes, including whether a user is connected via a satellite, is using a proxy server, and other factors.

Advertisers want high accuracy and sufficient geographic inventory—i.e., page impressions available from a given geographic location. To an advertising network provider, however, high accuracy requires higher confidence factors, which often reduces the available inventory for a given location.

### SUMMARY

The present invention provides methods, apparatuses and systems directed to enhancing operation of geo-targeting in network ad delivery systems. Particular implementations of the invention are directed to tuning confidence factors utilized in connection with geo-targeted advertising systems based on impression demand for a given geographic location and available inventory for that location.

### DESCRIPTION OF THE DRAWINGS

FIG. 1 is a schematic diagram that illustrates an example network environment in which particular implementations of the invention may operate.

FIG. 2 is a functional block diagram illustrating the functionality of a example network advertising system to which implementations of the invention have application.

FIG. 3 is an x-y graph showing an example relationship between impression inventory for a given geographic location as a function of confidence factor returned by a geo-targeting system.

FIGS. 4 and 5 are flow charts showing example methods associated with particular implementations of the invention.

FIG. 6 is a schematic diagram illustrating an example computing system architecture that may be used to implement one or more of physical servers.

### DESCRIPTION OF EXAMPLE EMBODIMENT(S)

### A. Overview

Particular embodiments of the present invention are related to geo-targeting systems that provide content, such as ad content, to users based on an identified geographic location. Geo Targeting by IP address and user insight typically have an accuracy expectation expressed as a confidence factor measured against them. Typically, ad systems target all inventory above a fixed accuracy measure in order to ensure large inventory while maintaining accuracy. Since improved accuracy can improve click through rates and improved inventory improves total targetable users, these relationships have a large impact on geo-targeting ad revenue. By using forecasting systems to determine how much inventory is required for a given time period, an accuracy filter can be set to the highest confidence factor possible to satisfy demand, thereby creating a maximum accuracy for the required amount of inventory. Furthermore, tradeoffs can be computed between the expected accuracy rate and the inventory rate to optimize the targetable users.

As discussed in more detail below, particular implementation of the invention modulate the threshold confidence factors corresponding to one or more geographic locations based on demand for impressions and anticipated impression inventory. Understanding the tradeoffs between available targetable inventory and accuracy is not a fixed problem, it varies on a daily basis. Therefore, it may be desirable to enable mechanisms that are capable of providing a safety buffer between targetable inventory and the accuracy capabilities of geo-targeting systems. This idea allows for precise tuning on a daily basis of our geo targeting.

In a particular implementation, advertising inventory forecasting systems can determine how many targetable users are required to satisfy advertiser demand for impressions directed to those targetable users for a given time interval (such as each day) and adjust the accuracy confidence threshold of a geo-targeting system in order to maximize accuracy against inventory. Revenue impact can be significant since each incremental addition to inventory allows for direct impact on advertising revenue. For example, the present invention can be configured to achieve either a significant increase in targetable inventory (increasing volume) OR a significant increase in accuracy (allowing for increased price) by optimizing on a periodic basis.

The present invention can be implemented in a variety of manners, as discussed in more detail below. Other implementations of the invention may be practiced without some or all of specific details set forth below. In some instances, well known structures and/or processes have not been described in detail so that the present invention is not unnecessarily obscured.

A.1. Example Network Environment

Particular implementations of the invention operate in a wide area network environment, such as the Internet, including multiple network addressable systems. Network cloud 60 generally represents one or more interconnected networks, over which the systems and hosts described herein can communicate. Network cloud 60 may include packet-based wide area networks (such as the Internet), private networks, wireless networks, satellite networks, cellular networks, paging networks, and the like.

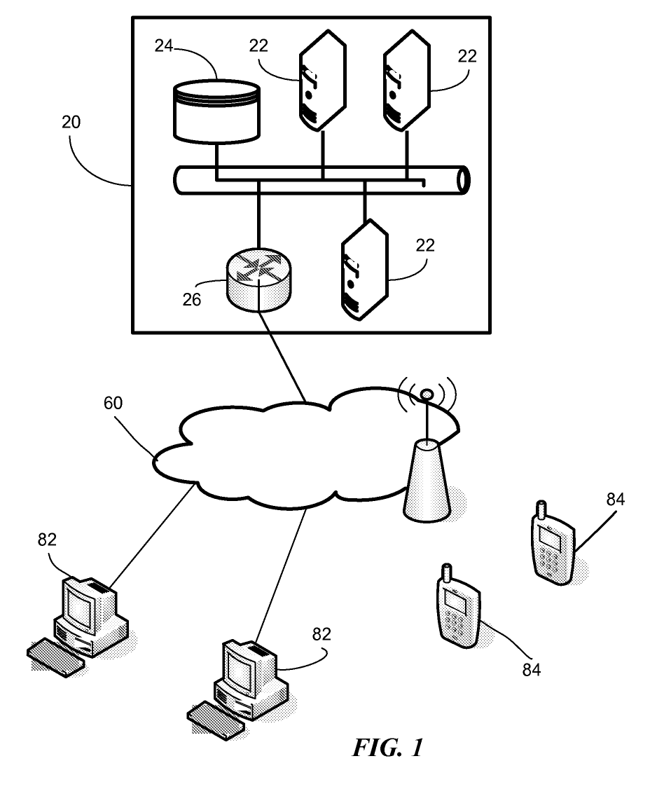

As FIG. 1 illustrates, a particular implementation of the invention can operate in a network environment comprising network application hosting site 20, such as an informational web site, social network site and the like. Although FIG. 1 illustrates only one network application hosting site, implementations of the invention may operate in network environments that include multiples of one or more of the individual systems and sites disclosed herein. Client nodes 82, 84 are operably connected to the network environment via a network service provider or any other suitable means.

Network application hosting site 20 is a network addressable system that hosts a network application accessible to one or more users over a computer network. The network application may be an informational web site where users request and receive identified web pages and other content over the computer network. The network application may also be a search platform, an on-line forum or blogging application where users may submit or otherwise configure content for display to other users. The network application may also be a social network application allowing users to configure and maintain personal web pages. The network application may also be a content distribution application, such as Yahoo! Music Engine®, Apple® iTunes®, podcasting servers, that displays available content, and transmits content to users.

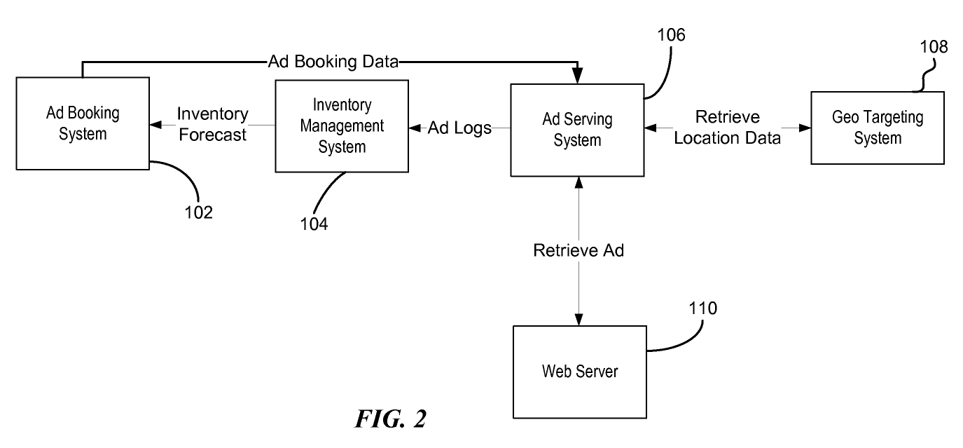

Network application hosting site 20, in one implementation, comprises one or more physical servers 22 and content data store 24. The one or more physical servers 22 are operably connected to computer network 60 via a router 26. The one or more physical servers 22 host functionality that provides a network application (e.g, a news content site, etc.) to a user. As discussed in connection with FIG. 2, in one implementation, the functionality hosted by the one or more physical servers 22 may include web or HTTP servers, ad serving systems, geo-targeting systems, and the like. Still further, some or all of the functionality described herein may be accessible using an HTTP interface or presented as a web service using SOAP or other suitable protocols.

Content data store 24 stores content as digital content data objects. A content data object or content object, in particular implementations, is an individual item of digital information typically stored or embodied in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Structurally, content data store 24 connotes a large class of data storage and management systems. In particular implementations, content data store 24 may be implemented by any suitable physical system including components, such as database servers, mass storage media, media library systems, and the like.

Network application hosting site 20, in one implementation, provides web pages, such as front pages, that include an information package or module describing one or more attributes of a network addressable resource, such as a web page containing an article or product description, a downloadable or streaming media file, and the like. The web page may also include one or more ads, such as banner ads, text-based ads, sponsored videos, games, and the like. Network application hosting site 20, in one implementation, further maintains one or more server logs that can be analyzed to determine the number of page impressions of a page and the number of click-thrus associated with links presented on pages. The number of impressions, in one particular implementation, can be defined as the number of requests, such as HTTP GET requests and other accesses, for a given web page or other network addressable resource. For example, the number of impressions for Yahoo!'s front page totals in the millions on a daily basis. HTTP or web servers can be configured to log client requests to allow for tracking of the number of impressions. Generally, web pages and other resources include hypertext links or other controls that a user can activate to retrieve additional web pages or resources. A user “clicks” on the hyperlink with a computer input device to initiate a retrieval request to retrieve the information associated with the hyperlink or control. HTTP or web servers similarly log these retrieval events which can be counted as click-thrus. This data and the attributes of the information packages associated with this data can be used to build predictive models that forecast inventory of page impressions. When analyzed in connection with geo-targeting data, the page impression inventory can be forecasted for one or more geographic locations.

FIG. 2 illustrates the functional modules hosted by network application hosting site 20 according to one particular implementation. As FIG. 2 illustrates, network application hosting site 20 may comprise ad booking system 102, inventory management system 104, ad serving system 106, geo-targeting system 108 and web server 110. The foregoing functional modules may be realized by hardware, executable modules stored on a computer readable medium, or a combination of both. The functional modules, for example, may be hosted on one or more of physical servers 22.

Web server 110 is an executable module that accepts HyperText Transport Protocol (HTTP) requests from web clients, such web browser client applications hosted on client computers 82, 84, and serving HTTP responses including data contents, such as HyperText Markup Language (HTML) documents and linked objects (images, advertisements, etc.). In one implementation, web server 110 has the capability of logging information about client requests and server responses to log files. Web server 110, as discussed above, may operate to deliver a network application, such as an informational web page or an internet search service.

Ad serving system 106 is operative to select ads for inclusion in web pages and other content transmitted to web site users. The ads may be banner ads, text ads and/or any other digital objects associated with advertiser sponsored content. For example, the ads may be banner ads to be transmitted in connection with a home page. The ads may be text based ads transmitted as sponsored search results in connection with a search results page. In one implementation, ad serving system 106 selects ads in response to a retrieval request from web server 110. The retrieval request may identify the web page Uniform Resource Locator (URL) requested by the user, the IP address associated with the user, an account identifier associated with the user. Ad serving system 106 may access geo-targeting system 108 against the IP address and/or account identifier of the user to identify one or more geographic locations associated with the user. The ad serving system 106 may use the identified geographic locations to select one or more geographically targeted ads to the user.

Geo-targeting system 108 is operative to return one or more geographic location identifiers in response to a request that identifies an IP address and/or other identifying information of a user. In one implementation, geo-targeting system 108 can rely exclusively on IP address or user identifying information that maps to additional information of the user (e.g., user account information that includes geographic information, such as a billing or account address). In other implementations, geo-targeting system 108 can be a hybrid system that relies on both information types. As to the use of IP addresses, geo-targeting system 108 may access a database of geo-targeting information against an IP address to return one or more geographic locations. The one or more geographic locations may be more general locations, such as country or region/state, and more specific locations, such as city, metropolitan region, zip code, and county. Each of the geographic location determinations returned by the geo-targeting system 108 may have a confidence factor that indicates the predicted accuracy of a given geographic location determination. Generally speaking, confidence factors associated with more general geographic locations are typically quite high, while confidence factors associated with more specific geographic locations may be relatively lower. The confidence factors may be expressed in a variety of manners, such as a percentage or some other score within a normalized range. For example, in response to an IP address (e.g., 216.143.100.234), a geo-targeting system may return a confidence factor of 99 for the state of “California” and a second confidence factor of 88 for the city of “Palo Alto.”

Inventory management system 104 is operative to access server logs and geo-targeting data to determine page impression inventory for one or more geographic locations. Using historical data of the server logs, inventory management system 104 is operative to forecast or estimate the impression inventory for a period of time, such as a day. These forecasts can be segregated to various aspects of the functionality supported by network application hosting site 20. For example, a page view inventory can be computed for an internet search service, while another page view inventory can be computed for a home page service. Additional inventory determinations can be made relative to a news service, a social networking site and the like.

Ad booking system 102 can present forecasted, targetable impression inventory to one or more advertisers in order to sell ad space. Ad booking system 102 allows advertisers to book ads for placement on one or more web sites, such as a search system, personal page, news service, social network site, job placement site and the like. In a particular implementation, advertisers can submit ad placement data including the ad creative or content (or an URL to the ad creative), the duration of the ad (e.g., 1 day, 1 week, etc.), the desired number of impressions (or click-thrus and other desired actions), and targeting parameters including one or more geo-targeting parameters. On a periodic basis, ad booking system 102, based on the ads placed and the geo-targeting parameters associated with the ads, can determine the impression demand for one or more geographic locations. For example, on a daily basis (as some ad placements expire and others are entered or renewed), ad booking system 102 can aggregate the total number of desired impressions for a given time interval (e.g., 24 hours, 12 hours, etc.) targeted to users in a given geographic location, such as the city of San Francisco, the county of Santa Clara in California, a metropolitan region or zone such as the city of Detroit and outer lying suburbs, the 94114 zip code, and the like. The impression demand for one or more geographic locations may then be transmitted to either the ad serving system 106 and/or the geo-targeting system 108 to assess the confidence factors that could be used to optimally satisfy the impression demands.

A.2. Client Nodes & Example Protocol Environment

Client node is a computer or computing device including functionality for communicating over a computer network. A client node can be a desktop computer 82, laptop computer, as well as mobile devices 84, such as cellular telephones, personal digital assistants. A client node may execute one or more client applications, such as a web browser, to access and view content over a computer network. In particular implementations, the client applications allow users to enter addresses of specific network resources to be retrieved. These addresses can be Uniform Resource Locators, or URLs. In addition, once a page or other resource has been retrieved, the client applications may provide access to other pages or records when the user “clicks” on hyperlinks to other resources. In some implementations, such hyperlinks are located within the web pages 30 and provide an automated way for the user to enter the URL of another page and to retrieve that page. The pages or resources can be data records including as content plain textual information, or more complex digitally encoded multimedia content, such as software programs or other code objects, graphics, images, audio signals, videos, and so forth.

The networked systems described herein can communicate over the network 60 using any suitable communications protocols. For example, client nodes 82, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. Still further, in particular implementations, the information transmitted between hosts may be formatted as HyperText Markup Language (HTML) documents. Other structured document languages or formats can be used, such as XML, and the like.

In some client-server protocols, such as the use of HTML over HTTP, a server generally transmits a response to a request from a client. The response may comprise one or more data objects. For example, the response may comprise a first data object, followed by subsequently transmitted data objects. In one implementation, for example, a client request may cause a server to respond with a first data object, such as an HTML page, which itself refers to other data objects. A client application, such as a browser, will request these additional data objects as it parses or otherwise processes the first data object.

Mobile client nodes 84 may use other communications protocols and data formats. For example, mobile client nodes 84, in some implementations, may include Wireless Application Protocol (WAP) functionality and a WAP browser. The use of other wireless or mobile device protocol suites are also possible, such as NTT DoCoMo's i-mode wireless network service protocol suites. In addition, the network environment may also include protocol translation gateways, proxies or other systems to allow mobile client nodes 84, for example, to access other network protocol environments. For example, a user may use a mobile client node 84 to capture an image and upload the image over the carrier network to a content site connected to the Internet.

A.3. Example Operation

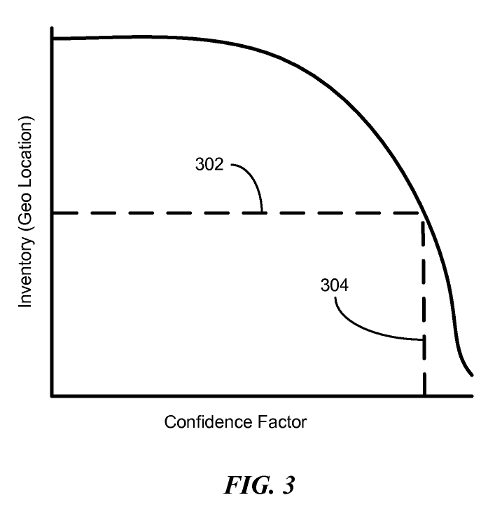

Ad serving system 106, for example, may assess page view inventory for one or more geographic locations as a function of confidence factor to develop a model that, for didactic purposes, can be graphically expressed as an x-y graph similar to FIG. 3. The graph illustrated in FIG. 3 models a relationship between available page view inventory (y-axis) for a given geographic location against confidence factor. Ad serving system 106 can model this relationship by accessing server log and geo-targeting data to assess the total number of page impressions over the range of confidence factors. For example, ad serving system 106 can construct the model based on observed IP addresses (inventory) over a given amount of time and the confidence levels corresponding to the IP addresses relative to a given geographic location. As FIG. 3 illustrates, at low confidence factors more targetable inventory is available, while less targetable inventory is available at higher confidence factors. As described in more detail below, implementations of the invention determine a confidence factor 304 that satisfies demand for targetable inventory for a given period of time.

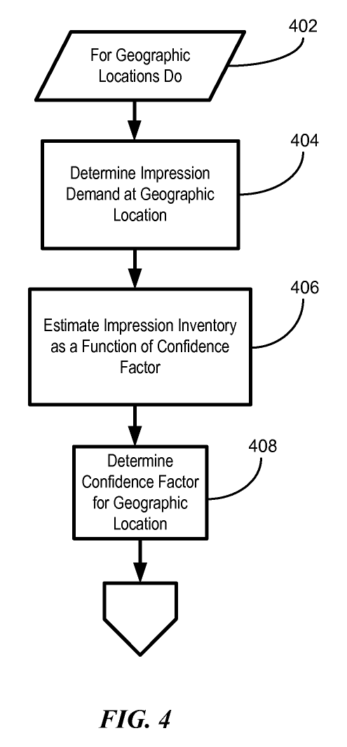

FIG. 4 illustrates an example process that can be implemented by ad serving system 106 to set confidence factor thresholds for one or more geographic locations. As FIG. 4 illustrates, ad serving system 106, for one or more geographic locations (402), determines the impression demand at a given geographic location (404) and estimates the impression inventory for that geographic location as a function of confidence factor (406). Ad serving system 106 then determines the confidence factor threshold to be used during a desired time interval for the geographic location that will optimally achieve the impression demand (408). In a particular implementation, ad serving system 106 sets the threshold confidence factor for a given geographic location to the greater of 1) a minimum confidence factor, and 2) the greatest confidence factor (cf), where the impression inventory (cf) equals the impression demand for the desired time interval. The minimum confidence factor can be set to any arbitrary value to influence the desired behavior of the ad serving system. For example, the minimum confidence factor can be set to ensure that the geo-targeting quality does not fall below a desired level regardless of impression demand. In addition, the minimum confidence factor can depend on the granularity of the given geographic location. For example, a lower minimum confidence factor can be used for smaller geographic regions, such as cities, and a relatively higher value can be used for larger geographic regions, such as states.

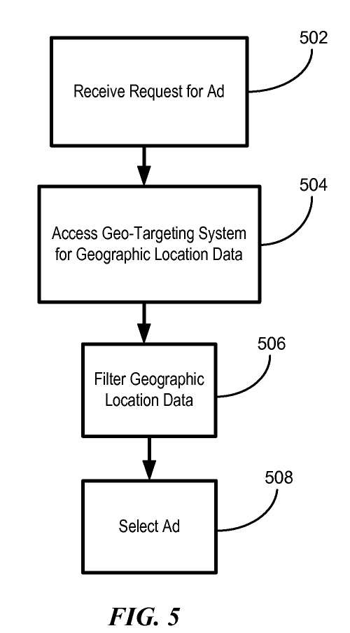

Ad serving system 106 can use the confidence factor thresholds discussed above for a given time interval or until a new set of thresholds have been computed. For example (and referring to FIG. 5), web server 110 may request one or more ads from ad serving system 106. Web server 110 may pass various parameters to the ad serving system, such as IP address, user identifier, a browser cookie appending to the user's HTTP request, the URL identified in the user's HTTP request, a web site indicator, a web site category or vertical indicator, and the like. Ad serving system 106, responsive to the request (502), may access geo-targeting system 108 against one or more items of user identifying information (such as IP address) to identifying one or more available geographic locations and corresponding confidence factors (504). For each returned geographic location, ad serving system may apply the confidence factor threshold to exclude or filter one or more of the geographic locations returned from the geo-targeting data (506). For example, assume for didactic purposes, that the threshold confidence factor for the city of Palo Alto, Calif. has been set to 89 and that, responsive to an request associated with a given user, the geo-targeting data returned a location of Palo Alto at a confidence factor of 85, and California at a confidence factor of 97. In this example, ad serving system 106 would exclude the geo-targeting item of Palo Alto during ad selection and retain (assuming it met the confidence factor threshold) the geo-targeting item of California. During selection of one or more targeted ads, ad serving system 106 then applies one or more ad selection algorithms to select ads based on the pool of booked ads (508). The ad selection algorithms themselves can vary considerably and still come within the scope of the present invention as the inventive aspects are directed to including or excluding geographic locations based on threshold confidence factors from ad selection, rather than the specific ad selection algorithm itself. Thus, the inventions described herein can be used in connection with banner and text based ad selection for use in connection with informational or entertainment web sites, or sponsored ad selection in connection with sponsored search systems, where geo-targeting parameters are utilized.

Other implementations of the invention are also possible. For example, the threshold confidence factors can be passed to geo-targeting system 108, which can then filter the results returned to ad serving system 106 (as opposed to having ad serving system 106 filter the data).

A.4. Example Computing System Architectures

While the foregoing systems can be implemented by a wide variety of physical systems and in a wide variety of network environments, the client and server host systems described below provide example computing architectures for didactic, rather than limiting, purposes.

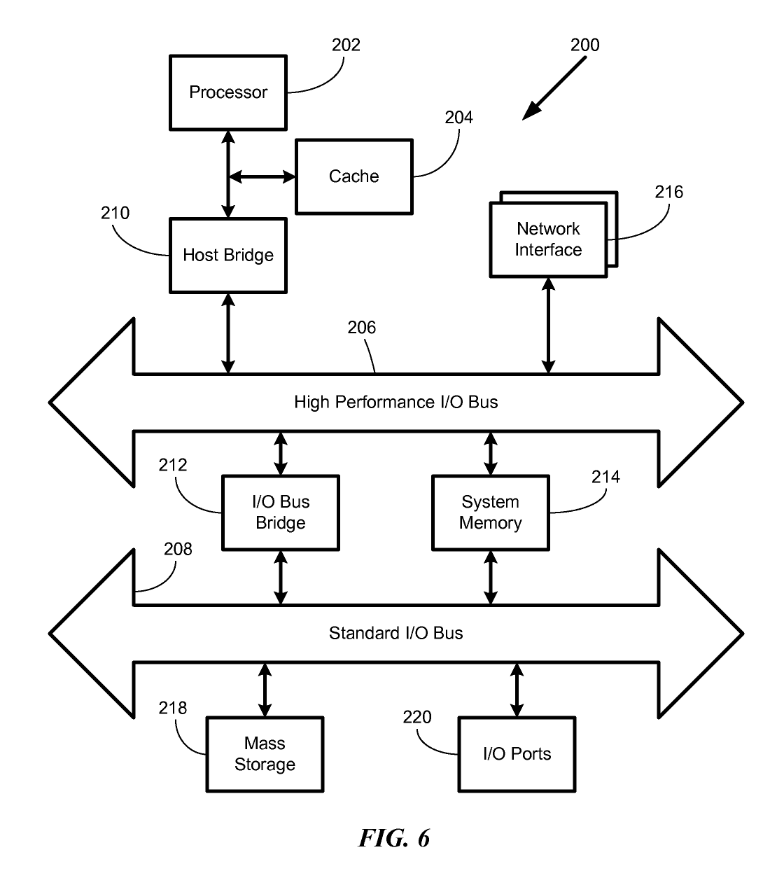

FIG. 6 illustrates an example computing system architecture, which may be used to implement a physical server. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the ×86-compatible processors manufactured by Intel Corporation of Santa Clara, Calif., and the ×86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one implementation, the operations of one or more of the physical servers described herein are implemented as a series of software routines run by hardware system 200. These software routines comprise a plurality or series of instructions to be executed by a processor in a hardware system, such as processor 202. Initially, the series of instructions may be stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like. Of course, other implementations are possible. For example, the server functionalities described herein may be implemented by a plurality of server blades communicating over a backplane.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

The present invention has been explained with reference to specific embodiments. For example, while embodiments of the present invention have been described as operating in connection with HTML and HTTP, the present invention can be used in connection with any suitable protocol environment. Furthermore, implementations of the invention can be used in systems directed to serving geo-targeted content other than ads to users. Other embodiments will be evident to those of ordinary skill in the art. It is therefore not intended that the present invention be limited, except as indicated by the appended claims.

What is claimed is:

1. A method for resolving a confidence factor used by a geo-targeting system, comprising
identifying an impression demand for a time interval for a geographic location;
estimating impression inventory for the geographic location during the time interval, wherein the impression inventory for the geographic location varies as a function of confidence factor; and
setting a threshold confidence factor used by a geo-targeting system during the time interval based on the impression inventory for the geographic location and the impression demand for the geographic location.

2. The method of claim 1 wherein the threshold confidence factor is set to the greatest confidence factor where the impression inventory for the geographic location satisfies the impression demand for the geographic location.

3. The method of claim 2 wherein the threshold confidence factor is set to the greater of a minimum threshold confidence factor and the greatest confidence factor where the impression inventory for the geographic location satisfies the impression demand for the geographic location.

4. The method of claim 1 further comprising filtering one or more geo-targeting data elements corresponding to a user based on the threshold confidence factor for the geographic location.

5. The method of claim 4 further comprising selecting one or more geo-targeted ads based on the filtered geo-targeting data.

6. The method of claim 1 wherein the geographic location is selected from a group comprising zip code, city, metropolitan area, state, region and country.

7. The method of claim 1 further comprising constructing a model, for the geographic location, that expresses a relationship between available page view inventory and confidence factors of a geo-targeting system.

8. An apparatus, comprising:
one or more processors;
one or more network interfaces;
a memory; and
computer-executable instructions carried on a computer readable medium, the instructions associated with a geo-targeting ad delivery service, the instructions readable by the one more processors, the instructions, when read and executed, for causing the one or more processors to:
identify an impression demand for a time interval for a geographic location;
estimate impression inventory for the geographic location during the time interval, wherein the impression inventory for the geographic location varies as a function of confidence factor; and
set a threshold confidence factor used by a geo-targeting system during the time interval based on the impression inventory for the geographic location and the impression demand for the geographic location.

9. The apparatus of claim 8 wherein the threshold confidence factor is set to the greatest confidence factor where the impression inventory for the geographic location satisfies the impression demand for the geographic location.

10. The apparatus of claim 9 wherein the threshold confidence factor is set to the greater of a minimum threshold confidence factor and the greatest confidence factor where the impression inventory for the geographic location satisfies the impression demand for the geographic location.

11. The apparatus of claim 8 further comprising computer-executable instructions for causing the one or more processors to filter one or more geo-targeting data elements corresponding to a user based on the threshold confidence factor for the geographic location.

12. The apparatus of claim 11 further comprising computer-executable instructions for causing the one or more processors to select one or more geo-targeted ads based on the filtered geo-targeting data.

13. The apparatus of claim 8 wherein the geographic location is selected from a group comprising zip code, city, metropolitan area, state, region and country.

14. The apparatus of claim 8 further comprising computer-executable instructions for causing the one or more processors to construct a model, for the geographic location, that expresses a relationship between available page view inventory and confidence factors of a geo-targeting system.

15. An article of manufacture comprising;
a computer readable medium; and
computer-executable instructions carried on the computer readable medium, the instructions associated with a geo-targeting ad delivery service, the instructions readable by a processor, the instructions, when read and executed, for causing the processor to:
identify an impression demand for a time interval for a geographic location;
estimate impression inventory for the geographic location during the time interval, wherein the impression inventory for the geographic location varies as a function of confidence factor; and
set a threshold confidence factor used by a geo-targeting system during the time interval based on the impression inventory for the geographic location and the impression demand for the geographic location.

16. The article of manufacture of claim 15 further comprising computer-executable instructions for causing the one or more processors Lo construct a model, for the geographic location, that expresses a relationship between available page view inventory and confidence factors of a geo-targeting system.

17. The article of manufacture of claim 16 further comprising computer-executable instructions for causing the one or more processors to filter one or more geo-targeting data elements corresponding to a user based on the threshold confidence factor for the geographic location.

18. The article of manufacture of claim 17 further comprising computer-executable instructions for causing the one or more processors to select one or more geo-targeted ads based on the filtered geo-targeting data.

19. A method comprising
receiving a request for targeted content, wherein the request includes a user identifier;
accessing a geo-targeting system for geographic location data associated with the user identifier, wherein the geographic location information comprises a geographic location and a confidence factor;
qualifying the geographic location information by applying a threshold confidence factor corresponding to a geographic location to the confidence factor provided by the geo-targeting system; and
accessing a data store of targeted content items, wherein one or more of the target content items is associated with a geographic targeting parameter; and
selecting one or more target content items based at least in part on the qualified geographic location information and geographic targeting parameters associated with the one or more target content items.

20. The method of claim 19 wherein the threshold confidence factor is set to the greater of a minimum threshold confidence factor and the greatest confidence factor where impression inventory for the geographic location satisfies an impression demand for the geographic location.
